(19) United States
(12) Patent Application Publication
(10) Pub. No.: US 2012/0082973 A1
(43) Pub. Date: Apr. 5, 2012

(54) INTERACTIVE VIRTUAL CLASSROOM PROVIDING MULTIDIRECTIONAL AND SELF-DIRECTED SCRIPTED LEARNING

(76) Inventor: Vu Hong Pham, La Palma, CA (US)

(21) Appl. No.: 12/897,799

(22) Filed: Oct. 5, 2010

(51) Int. Cl. G09B 7/00

(52) U.S. Cl. 434/350

(57) ABSTRACT

The present invention discloses an interactive virtual classroom for scripted self-directed learning and education. While self-directed learning is often unidirectional or bidirectional, this application features a multi-directional learning approach. The multidirectional approach involves interaction with virtual classmates that are programmed with artificial intelligence (AI). Interaction can be between the instructor and the user student, the user student and the AI students, the instructor and the AI students, between the AI students. The content provided within the classroom is scripted and customized depending on what is being taught.

An interactive virtual classroom allowing for self-directed scripted learning is disclosed. While self-directed learning is often unidirectional or bidirectional, this application features a multidirectional learning approach. The multidirectional approach involves interaction with virtual classmates that are programmed with artificial intelligence (AI). Interaction can be between the instructor and the student user, the student user and the AI students, the instructor and the AI students, and between the AI students. The content provided within the classroom is scripted and customized depending on what is being taught.

### BACKGROUND OF THE INVENTION

1. Field of the Invention

An interactive virtual classroom allowing for self-directed scripted learning is disclosed. While self-directed learning is often unidirectional or bidirectional, this application features a multidirectional learning approach. The multidirectional approach involves interaction with virtual classmates that are programmed with artificial intelligence (AI). Interaction can be between the instructor and the student user, the student user and the AI students, the instructor and the AI students, and between the AI students. The content provided within the classroom is scripted and customized depending on what is being taught.

2. Related Art

In applications where a virtual classroom is disclosed providing self-directed scripted learning, the approach is typically two-dimensional, either unidirectional or bidirectional. It commonly features an instructor or content that is projected to a student user. This application, in contrast, features a multidirectional learning approach, where students not only interact with the instructors but can also interact with fellow classmates.

Furthermore, previous self-directed learning patents generally involve live students. This application adds another dimensional on top of that by including classmates that are programmed with artificial intelligence. Various characters are used to represent these AI students and they interact via scripts that are programmed into the software. Each of the characters can individually direct questions towards the instructor and also participate in classroom discussion. The AI students can later evolve into avatars, thereby allowing users to interact with other live users on a real-time scale.

A distance learning environment is any learning environment where the student is physically separated from the instructor. Courses have been available in the past as correspondence courses where instruction material was mailed to the student who then completed the work and mailed back the results. Today, distance learning environments are often provided utilizing the Internet.

Therefore, it would be advantageous to have a method, system, and product for providing self-directed distance learning by permitting a user to control an educational presentation presented to the user by the distance learning environment.

### SUMMARY OF THE INVENTION

An interactive virtual classroom is disclosed for multidirectional and self-directed participatory learning. It involves a multidirectional approach that allows the user to interact not only with instructors, but also with virtual classmates that are programmed with artificial intelligence (AI). Interaction can be between the instructor and the student user, the student user and the AI students, the instructor and the AI students, and between the AI students.

The interactive computer students have the capability of asking relevant questions, making comments, and participating in classroom discussion. There is a raise your “hand” function to be on queue for asking the instructor questions, just like in a real-life classroom. The interface is customizable and includes dashboard skins as well as avatar creation capability. Users can also earn points to buy virtual tools, snacks, and unlock hidden characters and functions.

### BRIEF DESCRIPTION OF THE DRAWINGS

The components in the figures are not necessarily to scale, emphasis instead being placed upon illustrating the principles of the invention. In the figures, like reference numerals designate corresponding parts throughout the different views.

FIG. 1 is a flow chart illustrating the brainstorm process of the virtual classroom.

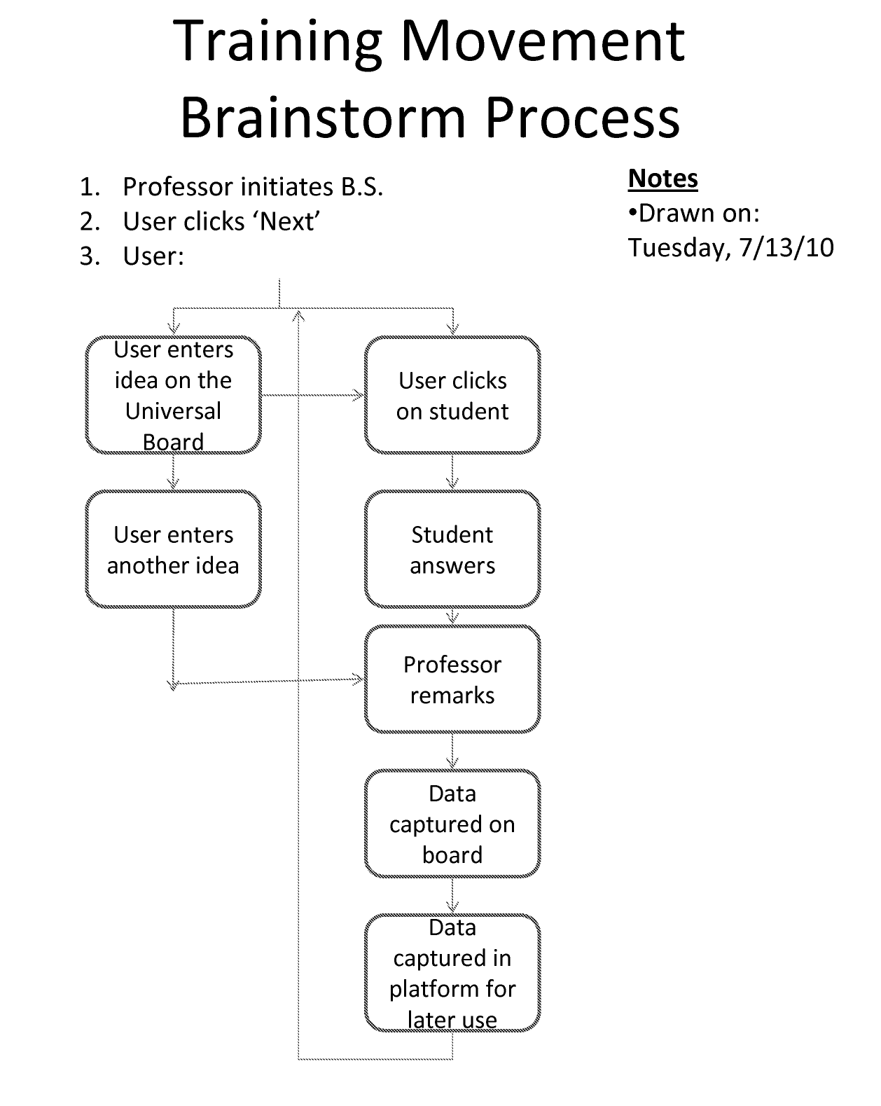

### DETAILED DESCRIPTION

As described below, the virtual class platform is modular, innovative, effective, interactive and fun.

### A. Modular

The virtual classroom disclosed in this invention is modular for the following reasons:

It includes one master platform with multiple interactive platforms to allow for scalability

It is adaptable to any topic because it is a learning system that is not dependable on the topic.

Each topic and learning will have its own signature algorithm and process.

It is customizable to any customer's learning and training needs.

It allows for more creativity of learning design and delivery.

Plug-ins allow for ease of modification and improvements and the user has the ability to choose from an entire toolbox of plug-ins, including:
Team building challenges
Work style assessments
Videos with interactive whiteboard
Downloadable worksheets
Live chat capabilities with instructors and students

Tools that are provided in the plug-in toolbox include:
Notepads to write takeaways
Whiteboard/Scratch paper function for problem solving
Calculator & calendar functions
Drawing tablet to create charts, graphs, diagrams

### B. Innovative

The virtual classroom disclosed in this invention is innovative for the following reasons:

It is a complete paradigm change from typical online learning.

It is an interactive classroom transcreated online

It provides for a fun, experiential classroom experience integrated online

It tracks metrics and has the ability to maintain, analyze, and track the progress of online learners.

It can be an online, computer-based platform, which is a reflection of the 21st century technology that businesses and education are progressing towards.

### C. Effective

The virtual classroom disclosed in this invention is effective for the following reasons:

It is time effective, allowing users to take the training at their convenience according to their individual schedules.

It is cost-effective and more affordable than in-house instruction.

It caters to all age groups, even K-12 students.

### D. Interactive and Fun

The virtual classroom disclosed in this invention is interactive and fun for the following reasons:

It involves interactive classmates that will ask questions and make comments.

It involves various instructors with distinct personalities.

It includes a dashboard that simulates desks with resources and tools on-hand.

Feedback and metrics are also provided through the following:
Multiple-choice quizzes with instant feedback scoring
DISC and other personality assessments
Work style assessments
Quiz benchmarks against famous people and other students
Survey analysis

What is claimed is:

1. A method for providing an interactive virtual classroom for multi-directional and self-directed scripted learning, comprising:
allowing the virtual classroom to be pre-scripted with customizable subject matter;
displaying a universal board that displays commands, content, information, directions, and questions;
providing virtual students that are programmed with artificial intelligence to participate in classroom discussion, direct questions to the instructor, and provide answers;
providing a virtual instructor that is also programmed with artificial intelligence to provide instruction, stimulate classroom participation, ask questions, answer questions, and teach the subject matter; and
allowing the user to participate and interact with the virtual students and the virtual instructor.

2. The method of claim 1, further comprising providing “sticky notes”, which allows the user to simulate taking notes in an interactive classroom without disrupting the flow of the classroom learning.

3. The method of claim 2, further comprising capturing and storing the sticky notes so that they can be accessed, reviewed, and modified by the user anytime.

4. The method of claim 1, further comprising allowing the user to move and rearrange the “sticky notes” to categorize and group the user's thoughts.

5. The method of claim 1, further comprising providing a “workbook”, which gives the user instant access to an array of worksheets that provides practice and helps with retention of the learned subject matter.

6. The method of claim 5, further comprising capturing and storing the “workbook” so that they can be accessed, reviewed, and modified by the user anytime.

7. The method of claim 1, further comprising “quizzes” that score the user based on the number of correct answers and the speed at which the user provides these answers.

8. The method of claim 1, further comprising a “help menu”, which provides the user with instructions on how to use the virtual classroom platform.

9. The method of claim 1, wherein the displaying a universal board step further allows the user to capture and store the universal board so that it can be accessed, reviewed, and modified by the user anytime.

10. The method of claim 1, wherein the providing virtual students step further includes evolving the virtual students into avatars, thereby allowing users to interact with other live users on a real-time scale.

11. A software program providing an interactive virtual classroom for multi-directional and self-directed scripted learning, comprising:
allowing the virtual classroom to be pre-scripted with customizable subject matter;
displaying a universal board that displays commands, content, information, directions, and questions;
providing virtual students that are programmed with artificial intelligence to participate in classroom discussion, direct questions to the instructor, and provide answers;
providing a virtual instructor that is also programmed with artificial intelligence to provide instruction, stimulate classroom participation, ask questions, answer questions, and teach the subject matter; and
allowing the user to participate and interact with the virtual students and the virtual instructor.

12. The software program of claim 11, further comprising providing “sticky notes”, which allows the user to simulate taking notes in an interactive classroom without disrupting the flow of the classroom learning.

13. The software program of claim 12, further comprising capturing and storing the sticky notes so that they can be accessed, reviewed, and modified by the user anytime.

14. The software program of claim 11, further comprising allowing the user to move and rearrange the “sticky notes” to categorize and group the user's thoughts.

15. The software program of claim 11, further comprising providing a “workbook”, which gives the user instant access to an array of worksheets that provides practice and helps with retention of the learned subject matter.

16. The software program of claim 15, further comprising capturing and storing the “workbook” so that they can be accessed, reviewed, and modified by the user anytime.

17. The method of claim 11, further comprising “quizzes” that score the user based on the number of correct answers and the speed at which the user provides these answers.

18. The method of claim 11, further comprising a “help menu”, which provides the user with instructions on how to use the virtual classroom platform.

19. The method of claim 11, wherein the displaying a universal board step further allows the user to capture and store the universal board so that it can be accessed, reviewed, and modified by the user anytime.

20. The method of claim 11, wherein the providing virtual students step further includes evolving the virtual students into avatars, thereby allowing users to interact with other live users on a real-time scale.
